(19) United States
(12) Patent Application Publication
(10) Pub. No.: US 2009/0211288 A1
(43) Pub. Date: Aug. 27, 2009

(54) COMBINATION MICROCHANNEL CONDENSER AND RADIATOR MOUNTING ARRANGEMENT

(75) Inventors: Robert S. Simeone, Bridgeport, NY (US); Jason A. Gough, Marcellus, NY (US); Eric J. Johnson, Palmyra, NY (US); John T. Steele, Marcellus, NY (US); Donald B. Hotaling, Jamesville, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRIER CORPORATION, Farmington, CT (US)

(21) Appl. No.: 12/391,799

(22) Filed: Feb. 24, 2009

Related U.S. Application Data
(60) Provisional application No. 61/031,138, filed on Feb. 25, 2008.

(51) Int. Cl. F25D 23/10; B23P 15/26

(52) U.S. Cl. 62/259.1; 29/890.035

(57) ABSTRACT

A transport refrigeration system includes a single frame for containing both a refrigeration condenser coil and an engine coolant radiator arranged in serial airflow relationship within a framework. Either one or the other may be removed and replaced without replacing the other.

### CROSS-REFERENCE TO RELATED APPLICATIONS

This application claims the benefit of and priority from U.S. Provisional Patent Application Ser. No. 61/031,138, filed Feb. 25, 2008, and entitled: Combination Microchannel Condenser and Radiator Mounting Arrangement.

### TECHNICAL FIELD

This invention relates generally to transport refrigeration systems and, more particularly, to a structure for mounting a microchannel heat exchanger condenser and a radiator in tandem in a single assembly.

In transport refrigeration systems, the refrigeration circuit includes a condenser coil for condensing refrigerant vapor into a liquid form. A diesel engine is commonly included with the system for the purpose of driving the generator and possibly the compressor. In order to cool the diesel engine, a liquid is normally circulated from the diesel engine through a radiator to be cooled and then back to the engine.

Heretofore, a single one piece plate fin coil incorporated both the condenser and the radiator in a single coil. Thus, if any portion of the coil were to be damaged or become inoperable for any reason, the entire coil assembly needed to be replaced.

### DISCLOSURE OF THE INVENTION

A single mounting and support structure is provided for supportably receiving both a refrigeration condenser coil and a radiator within the framework.

### BRIEF DESCRIPTION OF THE DRAWINGS

FIG. 1 is an exploded view of the present invention.

FIG. 2 is an assembled view thereof.

### DETAILED DESCRIPTION OF THE INVENTION

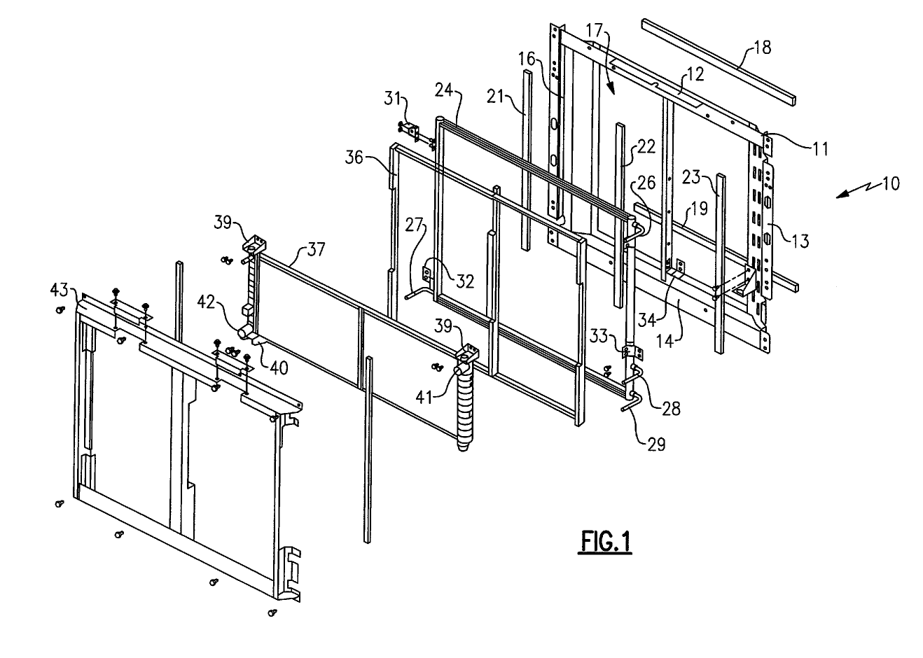

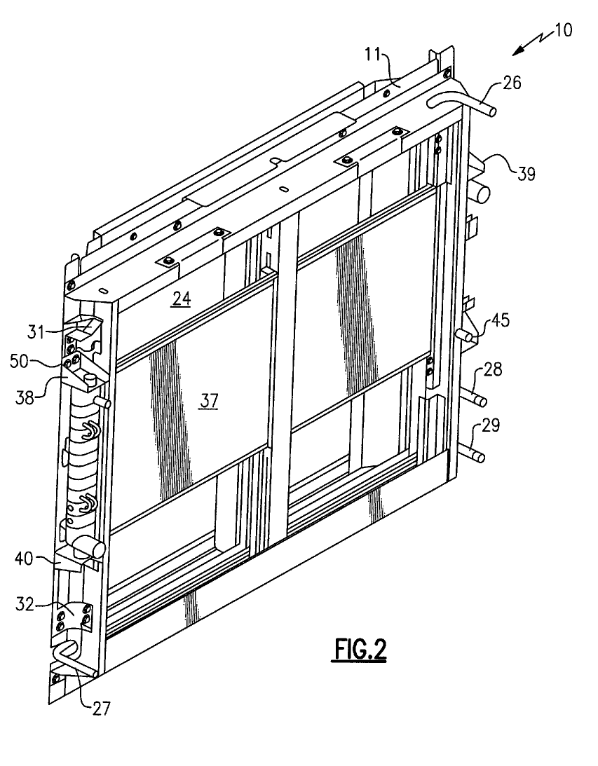

The invention as shown generally at 10 in FIGS. 1 and 2 includes a frame 11 having sides 12, 13, 14 and 16 defining an internal cavity 17 as shown. A plurality of insulating strips 18 and 19 are provided on the front side of the frame 11 and a plurality of insulating strips 21, 22 and 23 are provided on the rear side of the frame 11 in order to provide cushioning and the sealing off of air gaps.

The frame 11 can be composed of any suitable materials such as sheet metal or plastic, for example.

The cavity 17 is so sized and shaped so as to supportably receive a refrigerant condenser coil 24 therein. One type of coil which is particularly suited to such an installation is a microchannel heat exchanger (MCHX) condenser coil having an inlet 26 into which refrigerant vapor flows and an outlet 27 from which liquid refrigerant flows, with the inlet 26 being fluidly attached to the compressor discharge and the outlet 27 being fluidly connected to an expansion device of a refrigeration system. A subcooler inlet 28 and outlet 29 are also provided.

As will be seen, the condenser coil 27 is secured within the frame 11 by a plurality of brackets 31-34 attached by fasteners to both the condenser coil 24 and to the inner walls of the frame 11. These brackets are so designed and installed as to mitigate thermal expansion stresses and provide the rigidity for over-the-road use.

Also installed in the cavity 17 is a foam strip 36, which is generally formed in the shape and size as the condenser coil, to provide further cushioning, insulation and sealing between the components.

Also installed in the cavity 17, behind and adjacent the foam strip 36 is an engine coolant radiator coil 37, which is secured within the frame 11 by a plurality of brackets 38, 39, 40 and 45 and associated fasteners 50. An inlet 41 is fluidly connected to receive a liquid coolant from the diesel engine, and an outlet 42 is fluidly connected to deliver cooled coolant to the engine. The radiator coil 37 may be of any suitable type such as, for example, an automotive-style radiator.

Finally, a closure member 43 is installed behind the radiator 37 and is secured by fasteners, to the rear side of the frame 11 to complete the assembly.

As will be understood, the condenser coil 24 and the radiator coil 37 are arranged in serial airflow relationship such that the cooling air is caused to flow first through the condenser coil 24 and then through the radiator coil 37. Further, if either the radiator coil 37 or the condenser coil 24 becomes inoperable for any reason, the closure member 43 may be removed, and one or the other of the radiator 37 or condenser coil may be replaced without replacing the other.

While the present invention has been particularly shown and described with reference to the preferred mode as illustrated in the drawings, it will be understood by one skilled in the art that various changes in detail may be effected thereto without departing from the spirit and scope of the invention as defined by the claims.

We claim:

1. A mounting and support structure for a cooling portion of a transport refrigeration system which cooling portion includes both an engine coolant, radiator coil and a refrigeration condenser coil, comprising:
a frame having sides which define, in combination, a containing cavity;
said frame and cavity being so sized and shaped as to supportably and separately receive both the refrigeration condenser coil and the engine coolant radiator in said cavity; and
a plurality of fasteners for fastening each of the refrigeration condenser coil and engine coolant radiator in said frame.

2. A mounting and support structure as set forth in claim 1 wherein said refrigeration condenser coil and said engine coolant radiator coil are mounted in said frame in serial airflow relationship.

3. A mounting and support structure as set forth in claim 1 and including a plurality of insulation strips between said frame and said refrigeration condenser coil.

4. A mounting and support structure as set forth in claim 2 and including a foam strip between said refrigeration condenser coil and said engine coolant radiator coil.

5. A mounting and support structure as set forth in claim 4 wherein said foam strip includes four interconnected sides.

6. A mounting and support structure as set forth in claim 2 and including a closure member mounted on an outer side of said engine coolant radiator coil.

7. A method of mounting and supporting a cooling portion of a transport refrigeration system which includes both an engine coolant radiator coil and a refrigeration condenser coil, comprising the steps of:
providing a frame having sides which define, in combination, a containing cavity;
said frame and cavity being so sized and shaped as to supportably and separately receive both the refrigeration condenser coil and engine coolant radiator in said cavity; and
providing a plurality of fasteners for fastening each of the refrigeration condenser coil and engine coolant radiator in said frame.

8. A method as set forth in claim 7 wherein said refrigeration condenser coil and said engine coolant radiator coil are mounted in said frame in serial airflow relationship.

9. A method as set forth in claim 7 and including the step of providing a plurality of insulation strips between said frame and said refrigeration condenser coil.

10. A method as set forth in claim 8 and including the step of providing a foam strip between said refrigeration condenser coil and said engine coolant radiator coil.

11. A method as set forth in claim 10 wherein said foam strip includes four interconnected sides.

12. A method as set forth in claim 8 and including the step of providing a closure member mounted on an outer side of said engine coolant radiator coil.
